(19) United States
(12) Patent Application Publication
(10) Pub. No.: US 2014/0126822 A1
(43) Pub. Date: May 8, 2014

(54) Image Processing

(71) Applicants: James Patrick Underwood, Alexandria (AU); Bertrand Douillard, Chippendale (AU); Giulio Reina, Bari (IT); Annalisa Milella, Bari (IT)

(72) Inventors: James Patrick Underwood, Alexandria (AU); Bertrand Douillard, Chippendale (AU); Giulio Reina, Bari (IT); Annalisa Milella, Bari (IT)

(73) Assignee: THE UNIVERSITY OF SYDNEY, Sydney (AU)

(21) Appl. No.: 14/004,013

(22) PCT Filed: Mar. 9, 2012
(86) PCT No.: PCT/AU12/00249

§ 371 Date: Nov. 13, 2013

(30) Foreign Application Priority Data
Mar. 11, 2011 (AU) 2011900891

(51) Int. Cl. G01C 21/32; G06T 7/00

(52) U.S. Cl. CPC G01C 21/32; G06T 7/0057
USPC 382/174

(57) ABSTRACT

A method and apparatus for processing images, the method comprising: using a radar (4), generating a first image of an area of terrain (8); using a sensor (5), generating a second image of the area of terrain (8); performing an image segmentation process on the first image to identify a point in the first image as corresponding to a ground surface of the area of terrain (8); and projecting the identified point in the first image from the first image into the second image to identify a point in the second image as corresponding to the ground surface of the area of terrain (8). The method may further comprise: for the identified point in the second image, defining a sub-image of the second image containing that point; and performing a feature extraction process on the sub-image to identify points in the sub-image that correspond to the ground surface.

### FIELD OF THE INVENTION

The present invention relates to the processing of images.

### BACKGROUND

Autonomous vehicles may be implemented in many outdoor applications such as mining, earth moving, agriculture, and planetary-exploration.

Imaging sensors mounted on the vehicles facilitate vehicle perception. For example, images from sensors may be used for performing obstacle avoidance, task-specific target detection, and generation of terrain maps for navigation.

Ground segmentation tends to be critical for improving autonomous vehicle perception.

In urban environments, it tends to be possible to effectively perform a task of ground identification by exploiting structural or visual characteristics unique to a roadway.

However, in natural terrain, no a priori information about the ground surface is usually available. Furthermore, ground structure and appearance may significantly change during the operation of the vehicle. Thus, road detection algorithms based on specific cues tend to not be appropriate without human supervision.

To overcome the limitations of these methods, self-supervised terrain classification methods have been developed. For example, “Self-supervised monocular road detection in desert terrain”, H. Dahlkamp, A. Kaehler, D. Stevens, S. Thrun, and G. Bradski, Proceedings of the Robotics Science and Systems Conference, Philadelphia, Pa., 2006, discloses a self-supervised ground detection approach using a laser range finder and a color camera.

The fusion of data from radar and vision (i.e. visible light detecting cameras) has been discussed in several works. This type of data fusion has typically been developed in the context of driver assistance systems. Furthermore, this type of data fusion tends to feature object detection and classification modules, for example, those described in “Rader-Vision Fusion for Object Classification”, Z. Ji and D. Prokhorov, 11th International Conference on Information Fusion, 2008.

### SUMMARY OF THE INVENTION

In a first aspect the present invention provides a method for processing images, the method comprising: using a radar, generating a first image of an area of terrain; using a sensor, generating a second image of the area of terrain; performing an image segmentation process on the first image to identify a point in the first image as corresponding to a ground surface of the area of terrain; and projecting the identified point in the first image from the first image into the second image to identify a point in the second image as corresponding to the ground surface of the area of terrain.

The method may further comprise: for the identified point in the second image, defining a sub-image of the second image containing that point; and performing a feature extraction process on the sub-image to identify points in the sub-image that correspond to the ground surface of the area of terrain.

The method may further comprise constructing a model of the particular object or terrain feature using the points in the sub-image that correspond to the ground surface of the area of terrain.

The model may be a multivariate Gaussian distribution.

The method may further comprise using the model to construct a classifier for classifying a region in a third image as either corresponding to the ground surface of the area of terrain or not corresponding to the ground surface of the area of terrain.

The classifier may be a one-class classifier.

The classifier may classify the region depending on the Mahalanobis distance between the region and the model.

The sensor may be an imaging sensor.

The sensor may be arranged to detect electromagnetic radiation.

The sensor may be a camera arranged to detect visible light.

In a further aspect, the present invention provides apparatus for processing images, the apparatus comprising: a radar arranged to generate a first image of an area of terrain; a sensor arranged to generate a second image of the area of terrain; and one or more processors arranged to: perform an image segmentation process on the first image to identify a point in the first image as corresponding to a ground surface of the area of terrain; and project the identified point in the first image from the first image into the second image to identify a point in the second image as corresponding to the ground surface of the area of terrain.

In a further aspect, the present invention provides a vehicle comprising the apparatus according to the above aspect.

The vehicle may be an autonomous vehicle.

The vehicle may be a land-based vehicle.

In a further aspect, the present invention provides a program or plurality of programs arranged such that when executed by a computer system or one or more processors it/they cause the computer system or the one or more processors to operate in accordance with the method of any of the above aspects.

In a further aspect, the present invention provides a machine readable storage medium storing a program or at least one of the plurality of programs according to the above aspect.

### BRIEF DESCRIPTION OF THE DRAWINGS

FIG. 1 is a schematic illustration (not to scale) of a vehicle in which an embodiment of a process of performing ground segmentation in the vicinity of the vehicle is implemented;

FIG. 2 is a schematic illustration (not to scale) of an example terrain modelling scenario in which the vehicle is used to scan a terrain area;

FIG. 3 is a process flowchart showing certain steps of an embodiment of ground segmentation process implemented by the vehicle;

FIG. 4 is a process flowchart showing certain steps of an embodiment of the training process performed during the ground segmentation process; and

FIG. 5 is a process flowchart showing certain steps of a process of using the visual classifier to perform the segmentation of a whole image.

### DETAILED DESCRIPTION

The terminology “ground” is used herein to refer to a geometric configuration of an underlying supporting surface of an environment or a region of an environment. The underlying supporting surface may, for example, include surfaces such as the underlying geological terrain in a rural setting, or the artificial support surface in an urban setting, either indoors or outdoors.

The terminology “ground based” is used herein to refer to a system that is either directly in contact with the ground, or that is mounted on a further system that is directly in contact with the ground.

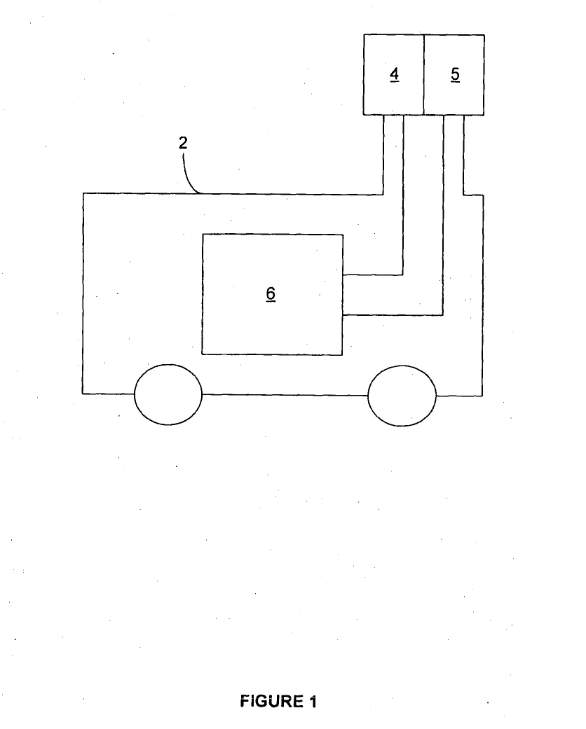

FIG. 1 is a schematic illustration (not to scale) of a vehicle 2 in which an embodiment of a process of performing ground segmentation in the vicinity of the vehicle 2 is implemented. This process will hereinafter be referred to as a “ground segmentation process”.

In this embodiment, the vehicle 2 comprises a radar system 4, a camera 5, and a processor 6.

In this embodiment, the vehicle 2 is an autonomous and unmanned ground-based vehicle. During operation, the ground-based vehicle 2 is in contact with a surface of an area of terrain area, i.e. the ground. Thus, in this embodiment, the radar system is a ground-based system (because it is mounted in the ground-based vehicle 2).

In this embodiment, the radar system 4 is coupled to the processor 6.

In this embodiment, the radar system 4 comprises a mechanically scanned millimetre-wave radar. The radar is a 95-GHz Frequency Modulated Continuous Wave (FMCW) millimetre-wave radar that reports the amplitude of echoes at ranges between 1 m and 120 m. The wavelength of the emitted radar signal is 3 mm. The beam-width of the emitted radar signal is 3.0° in elevation and 3.0° in azimuth. A radar antenna of the radar system 4 scans horizontally across the angular range of 360°.

In operation, the radar system 4 radiates a continuous wave (CW) signal towards a target through an antenna. An echo is received from the target by the antenna. A signal corresponding to the received echo is sent from the radar system 4 to the processor 6.

In this embodiment, the camera 5 is coupled to the processor 6.

In this embodiment, the camera 5 is a Prosilica Mono-CCD megapixel Gigabit Ethernet camera. Also, the camera 5 points downwards and in front of the vehicle 2.

In operation, the camera 5 captures images of the ground in front of the vehicle. A signal corresponding to the captured images is sent from the camera 5 to the processor 6.

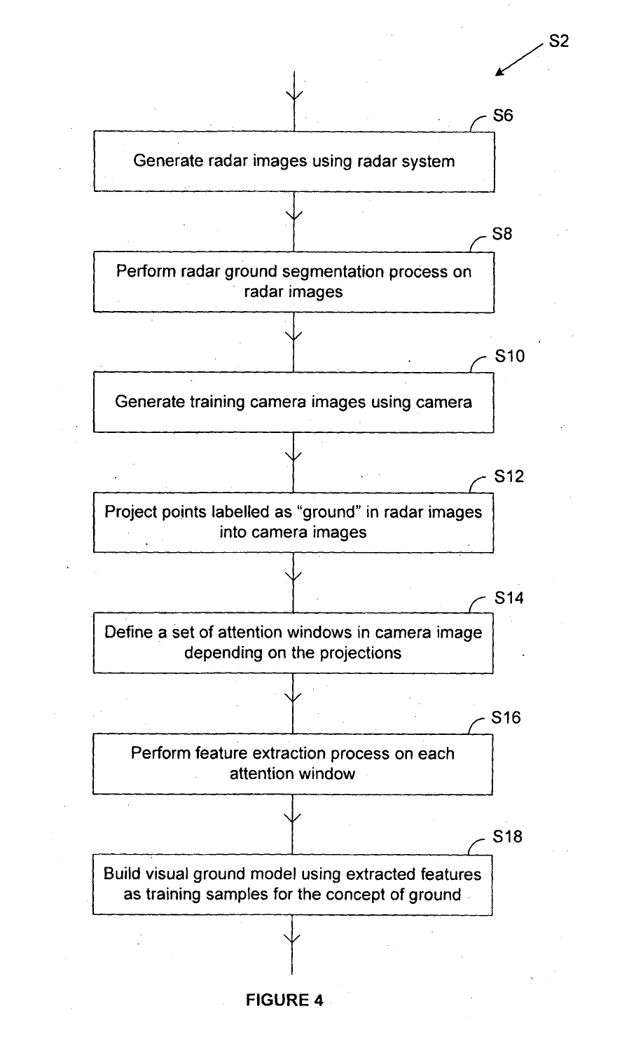

In this embodiment, the processor 6 processes the signals received from the radar system 4 and the camera 5, as described in more detail later below with reference to FIG. 4. In this embodiment, the fields of view of the radar system 4 and the camera 5 overlap on the ground.

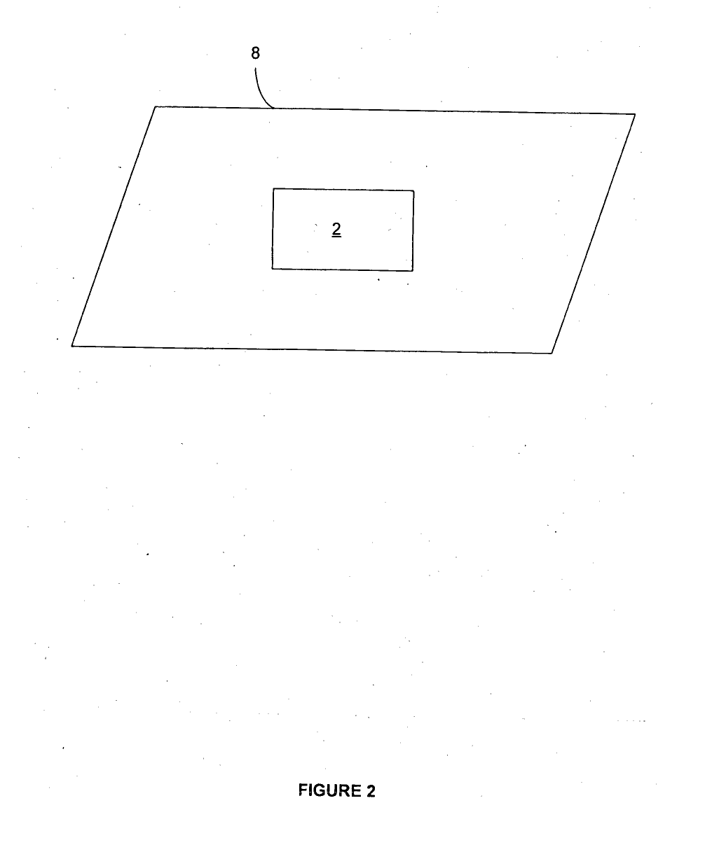

FIG. 2 is a schematic illustration (not to scale) of an example terrain modelling scenario in which the vehicle 2 is used to scan a terrain area 8. In this scenario, the vehicle 2 uses the radar system 4 and the camera 6 to scan the terrain area 8.

In this embodiment, the area of terrain is an open rural environment.

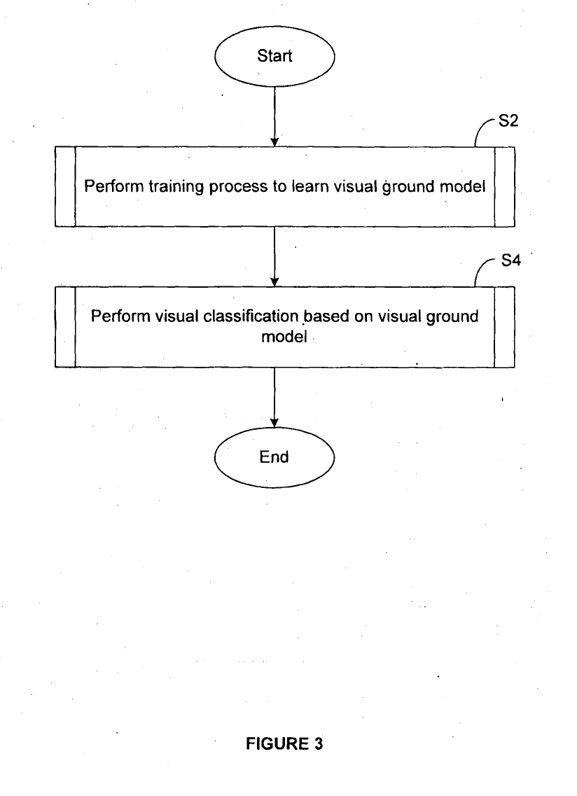

FIG. 3 is a process flowchart showing certain steps of an embodiment of ground segmentation process implemented by the vehicle 2.

At step s2, a training process is performed by the vehicle 2 to construct a visual model of the ground (i.e. a model of the ground as detected by the visual camera 5).

The training process is described in more detail later below with reference to FIG. 4.

At step s4, the visual classifier is used to perform scene segmentation based on the ground model.

FIG. 4 is a process flowchart showing certain steps of an embodiment of the training process performed at step s2 of the ground segmentation process.

At step s6, the radar system 4 is used to generate a set of training radar samples.

In this embodiment, the radar system 4 radiates a (CW) signal on to the area of terrain 8 in front of the vehicle 2. An echo is received by the antenna of the radar system 4, and a signal corresponding to the received echo is sent from the radar system 4 to the processor 6.

At step s8, the processor 6 performs a Radar Ground Segmentation (RGS) process on the signals (i.e. the set of training data from the radar system 4) received from the radar system 4.

Further details on the RGS process performed by the processor 6 in this embodiment can be found in “Radar-based Perception for Autonomous Outdoor Vehicles”, G. Reina, J. Underwood, G. Brooker, and H. D. Durrant-Whyte, submitted to the Journal of Field Robotics, which is incorporated herein by reference.

In this embodiment, for each radar scan, an RGS process is performed to detect and range a set of background points in radar-centred coordinates.

Thus, in this embodiment, the processor 6 applies the RGS process to the radar-generated training images of the area of terrain 8 to detect objects belonging to three broad categories, namely “ground”, “non-ground” (i.e. obstacles), or “unknown”.

At step s10, the camera 5 captures a set of training (visual) images of the area of terrain 8 in front of the vehicle. A signal corresponding to the captured training images is sent from the camera 5 to the processor 6.

At step s12, the points in the training radar images labelled as “ground” at step s8 are projected into the training camera images (received by the processor 6 at step s10).

In this embodiment, this projection of the radar-centred points labelled as “ground” into the camera images is performed using a conventional camera perspective transformation.

At step s14, for each point projected into a camera image, an “attention window” (i.e. a sub-image) containing that point is defined. In this embodiment, a defined attention window is fixed in the camera image. Also, in this embodiment, each attention window corresponds to a ground portion (i.e. a region in the area of terrain 8) of approximately 0.30 m×0.30 m.

At step s16, the attention windows, i.e. the sub-images defined at step s14, are processed using a feature extraction process.

In this embodiment, this feature extraction process is a conventional feature extraction process.

In this embodiment, the feature extraction process is used to generate a four-dimensional feature vector for each attention window. Each feature vector is a concatenation of visual textural descriptors (e.g. contrast and energy) and colour descriptors (e.g. mean intensity values in the normalized red and green colour planes). In other embodiments, different (e.g. more complex visual descriptors) may be used.

The feature extraction process is performed on the sub-images to extract visual features from the sub-images. Thus, by performing the feature extraction process on the sub-images (that were determined using points in the radar images labelled as “ground”), the visual appearance of the ground is advantageously incorporated.

At step s18, the extracted feature vectors are used as training samples for the concept of “ground” during the building of the ground model.

In this embodiment, this building of the ground model is performed using a conventional technique.

In this embodiment, visual ground model is modelled as a multivariate Gaussian distribution.

Thus, a training process in which points in a radar image labelled as “ground” are used to guide the selection of patches in the camera image which, in turn, are used to construct a visual model of the ground is provided.

In this embodiment, after performing the above described training process to determine a visual ground model, a visual classifier is determined using the visual ground model, and is used to perform a segmentation of a camera (i.e. visual) image.

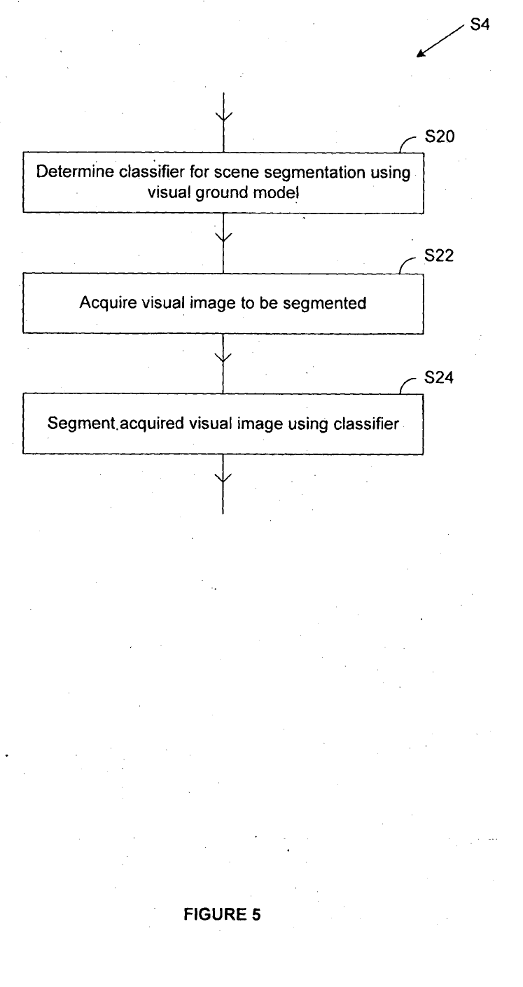

FIG. 5 is a process flowchart showing certain steps of a process of using the visual classifier to perform the segmentation of a whole image.

At step s20, the visual ground model, which was determined during the training process (i.e. step s2), is used to determine a Mahalanobis distance-based one-class classifier for scene segmentation.

In this embodiment, the training camera images captured at step s10 of the training process (described above with reference to FIG. 4) are used to determine the classifier for scene segmentation.

One-class classification methods are generally useful in the case of two-class classification problems where one class (typically referred as to the “target class”) is relatively well-sampled, while the other class (typically referred to as the “outlier class”) is relatively under-sampled or is difficult to model. Also, typically a one class-classifier is adopted to construct a decision boundary that separates instances of the target class from all other possible objects. In this embodiment, ground samples are the target class, while non-ground samples (i.e., obstacles) are the outlier class. Further discussion concerning the problem of one-class classification can be found in “One-Class Classification, Concept Learning in the Absence of Counter Examples”, D. M. J. Tax, PhD Thesis, Delft University of Technology, Delft, Netherlands, 2001, which is incorporated herein by reference.

In this embodiment, a one class classifier is constructed. In open rural environments non-ground samples are typically sparse. Thus, only positive ground samples are used in this embodiment. In this embodiment, the problem is formulated as a distribution modelling problem in which a distribution to estimate is that of the ground class. However, in other embodiments a different type of classifier may be constructed. For example, in other embodiments both ground and non-ground samples from RGS process may be exploited to train a two-class classifier.

In this embodiment, there are N_{G} ground patterns. The ground pattern i is represented by its m-dimensional row feature vector f_{G}ⁱ with m being the number of feature variables.

These vectors constitute a training set X, which, in this embodiment, is expressed In the form of a N_{G}×m matrix where each row is an observation and each column is a variable.

The sample mean of the data in X is denoted by μ.

The sample covariance of the data in X is denoted by Σ

The ground model is denoted by M(μ, Σ).

Given a new pattern with its feature vector f, the squared Mahalanobis distance between f and M(μ, Σ) is defined as:

d²=(f−μ)Σ⁻¹(f−μ)^{T}

In this embodiment, the pattern with feature vector f is an outlier, i.e. it is classified as a non-ground sample, if d² is greater than a pre-determined threshold.

Also, in this embodiment, the pattern with feature vector f is not an outlier, i.e. it is classified as a ground sample, if its squared Mahalanobis distance is less than or equal to a pre-determined threshold.

In this embodiment, this pre-determined threshold is computed as a quantile of a chi-square distribution with m degrees of freedom.

In this embodiment the ground class is advantageously continuously updated during the vehicle motion. In this embodiment, this is achieved by continuously rebuilding the ground model M(μ, Σ) using the feature vectors obtained by the most recent radar scans.

At step s22, a visual image to be segmented and classified is acquired using the camera 5. A signal corresponding to the captured visual image is sent from the camera 5 to the processor 6.

At step s24, the processor 6 classifies the whole visual image using the classifier determined at step s20.

Thus a process of performing online ground segmentation is provided.

Also, a self-supervised ground segmentation method using a radar and visible camera systems is provided.

An advantage provided by the above described ground segmentation process is that the visual model of the ground (produced by performing the above described training process) can be used to facilitate high level tasks, such as terrain characterization, road finding, and visual scene segmentation. Also, the visual model of the ground can be used to supplement the radar sensor by solving radar ambiguities, e.g. which derive from reflections and occlusions. Problems caused by radar ambiguities tend to be reduced or alleviated by classifying radar unknown returns through comparison of the visual feature vectors extracted from the unknown-labelled visual patches with the ground model. In this sense, the visual classifier advantageously supplements the radar system to solve uncertain situations.

The combination of a radar-based segmentation method with a vision-based classification system is combined advantageously to incrementally construct a visual model of the ground as the vehicle that the radar and camera are mounted on moves.

A further advantage of the above described ground segmentation process is that the process may be advantageously used to assist a driver of a vehicle, e.g. by performing obstacle detection and classification.

Also, radar data is used to select attention windows in the camera image and the visual content of these windows is analysed for classification purposes. The radar system is used prior to analysis of the camera (i.e. visual) images to identify radar ground returns and automatically label the selected visual attention windows, thus reducing or eliminating a need for time consuming manual labelling. In other words, the system performs automatic online labelling based on a radar ground segmentation approach prior to image analysis. This avoids time consuming manual labelling to construct the training set. Also, no a priori knowledge of the terrain appearance is required.

Since the ground model can be continuously updated based on the most recent radar scans, this approach tends to be particularly suited to long range navigation conditions. Ground segmentation is generally difficult, as the terrain appearance is affected by a number of factors that are not easy to measure and change over time, such as terrain type, presence of vegetation, and lighting conditions. This is particularly true for long-range navigation. The above described process addresses this problem by learning adaptively the ground model by continuously training the classifier using the most recent scans obtained by the radar.

Apparatus, including the processor 6, for implementing the arrangements described herein, and performing the method steps described herein, may be provided by configuring or adapting any suitable apparatus, for example, one or more computers or other processing apparatus or processors, and/or providing additional modules. The apparatus may comprise a computer, a network of computers, or one or more processors, for implementing instructions and using data, including instructions and data in the form of a computer program or plurality of computer programs stored in or on a machine readable storage medium such as computer memory, a computer disk, ROM, PROM etc., or any combination of these or other storage media.

It should be noted that certain of the process steps depicted in the flowcharts of FIGS. 3 to 5, and described above may be omitted or such process steps may be performed in differing order to that presented above and shown in the Figures. Furthermore, although all the process steps have, for convenience and ease of understanding, been depicted as discrete temporally-sequential steps, nevertheless some of the process steps may in fact be performed simultaneously or at least overlapping to some extent temporally.

In the above embodiments, the vehicle is an autonomous and unmanned land-based vehicle. However, in other embodiments the vehicle is a different type of vehicle. For example, in other embodiments the vehicle is a manned and/or semi-autonomous vehicle. Also, in other embodiments, the above described radar ground segmentation process is implemented on a different type of entity instead of or in addition to a vehicle. For example, in other embodiments the above described system/method may be implemented in an Unmanned Aerial Vehicle, or helicopter (e.g. to improve landing operations), or as a se-called “robotic cane” for visually impaired people. In another embodiment, the above described system/method is implemented in a stationary system for security application, e.g. a fixed area scanner for tracking people or other moving objects by separating them from the ground return.

In the above embodiments, the radar is a 95-GHz Frequency Modulated Continuous Wave (FMCW) millimetre-wave radar that reports the amplitude of echoes at ranges between 1 m and 120 m. The wavelength of the emitted radar signal is 3 mm. The beam-width of the emitted radar signal is 3.0° in elevation and 3.0° in azimuth. However, in other embodiments the radar is a different appropriate type of radar e.g. a radar having different appropriate specifications.

In the above embodiments, the camera is a Prosilica Mono-CCD megapixel Gigabit Ethernet camera. Also, the camera points downwards and in front of the vehicle. However, in other embodiment the camera is a different appropriate type of camera e.g. a camera having different appropriate specifications, and/or a camera arranged to detect radiation having different frequency/wavelength (e.g. an infrared camera, an ultraviolet camera etc.). Also, in other embodiments, the camera is arranged differently with respect to the vehicle, e.g. having a different facing. Furthermore, the camera may be fixed or movable relative to the vehicle that it is mounted on. Furthermore, the radar may be arranged to operate partially, or wholly, in the radar near-field, or partially or wholly in the radar far-field.

In the above embodiments, the radar system radiates a continuous wave (CW) signal towards a target through an antenna. However, in other embodiments, the radar signal has a different type of radar modulation.

In the above embodiments, the vehicle is used to implement the ground segmentation process in the scenario described above with reference to FIG. 2. However, in other embodiments the above described process is implemented in a different appropriate scenario, for example, a scenario in which a variety of terrain features and or objects are present, and/or in the presence of challenging environmental conditions such as adverse weather conditions or dust/smoke clouds.

In the above embodiments, at step s8, the processor performs a Radar Ground Segmentation (RGS) process. This process is as described in “Radar-based Perception for Autonomous Outdoor Vehicles”. However, in other embodiments, a different process is performed on the radar images to identify radar image points that correspond to the “ground”. For example, a process in which radar image points are classified as a different classification instead of or in addition to the classifications of “ground”, “not ground”, or “uncertain” may be used.

1. A method for processing images, the method comprising:
using a radar, generating a first image of an area of terrain;
using a sensor, generating a second image of the area of terrain;
performing an image segmentation process on the first image to identify a point in the first image as corresponding to a ground surface of the area of terrain; and
projecting the identified point in the first image from the first image into the second image to identify a point in the second image as corresponding to the ground surface of the area of terrain.

2. A method according to claim 1, the method further comprising:
for the identified point in the second image, defining a sub-image of the second image containing that point; and
performing a feature extraction process on the sub-image to identify points in the sub-image that correspond to the ground surface of the area of terrain.

3. A method according to claim 2, the method further comprising constructing a model of the particular object or terrain feature using the points in the sub-image that correspond to the ground surface of the area of terrain.

4. A method according to claim 3, wherein the model is a multivariate Gaussian distribution.

5. A method according to claim 3, the method further comprising using the model to construct a classifier for classifying a region in a third image as either corresponding to the ground surface of the area of terrain or not corresponding to the ground surface of the area of terrain.

6. A method according to claim 5, wherein the classifier is a one-class classifier.

7. A method according to claim 5, wherein the classifier classifies the region depending on the Mahalanobis distance between the region and the model.

8. A method according to any of claim 1, wherein the sensor (5) is arranged to detect electromagnetic radiation.

9. A method according to claim 8, wherein the sensor is a camera arranged to detect visible light.

10. Apparatus for processing images, the apparatus comprising:
a radar arranged to generate a first image of an area of terrain;
a sensor arranged to generate a second image of the area of terrain; and
one or more processors arranged to:
perform an image segmentation process on the first image to identify a point in the first image as corresponding to a ground surface of the area of terrain; and
project the identified point in the first image from the first image into the second image to identify a point in the second image as corresponding to the ground surface of the area of terrain.

11. A vehicle comprising the apparatus of claim 10.

12. A vehicle according to claim 11, wherein the vehicle is an autonomous vehicle.

13. A vehicle according to claim 11, wherein the vehicle (2) is a land-based vehicle.

14. A program or plurality of programs arranged such that when executed by a computer system or one or more processors it/they cause the computer system or the one or more processors to operate in accordance with the method of any of claim 1.

15. A machine readable storage medium storing a program or at least one of the plurality of programs according to claim 14.
